(19) United States
(12) Patent Application Publication
(10) Pub. No.: US 2026/0049204 A1
(43) Pub. Date: Feb. 19, 2026

(54) Garnet and Glass Composite and Uses

(71) Applicant: Tundra Composites, LLC, White Bear Lake, MN (US)

(72) Inventor: John Kroll, Blaine, MN (US)

(73) Assignee: Tundra Composites, LLC, White Bear Lake, MN (US)

(21) Appl. No.: 19/298,513

(22) Filed: Aug. 13, 2025

Related U.S. Application Data
(60) Provisional application No. 63/683,475, filed on Aug. 15, 2024.

(51) Int. Cl. C08K 9/02; C03C 12/00; C08J 3/22; C09K 3/14

(52) U.S. Cl. CPC C08K 9/02; C03C 12/00; C08J 3/22; C09K 3/1436; C08J 2323/00; C08K 2201/003; C08K 2201/005

(57) ABSTRACT

A composite material comprising a garnet particle coated glass core particle. The composite is a useful abrasive material. The claimed composite is used in the formation of molded thermoplastic objects. The composite particle size and surface improves thermoplastic rheology and modulus and tensile properties.

### FIELD

The composite particle having size and surface topography improves thermoplastic rheology and modulus and tensile properties. The claimed composite structure suggests a variety of uses. It can be used in the formation of molded thermoplastic objects or as an abrasive.

### BACKGROUND

The use of solid or hollow glass particles and spherical glass materials in the molding of thermoplastic materials is known. Including a glass particulate in a thermoplastic molding process can reduce costs and similarly improve the rheology of the molten thermoplastic material during molding. Glass spheres are commonly used in the plastics industry to reduce shrinkage during molding and extrusion applications. In some highly engineered polymer systems, the cost per unit volume of glass beads is often less than that of the base resin and thereby they are used as a rheologically favorable lower cost filler. The glass spheres are rheologically favorable due the shape of the particle as passed through melt processing equipment and associated dies etc. (they roll well). Additionally, they are readily available with a vast array of surface chemistries to enable chemical interaction of the glass bead to the polymer matrix in which it is placed as an effort to enable the glass beads to couple to the polymer and function as a reinforcement filler within the molded/extruded article. This added value add comes with an added cost. Molding processes typically include such processes using a melt polymer phase in either extrusion or injection molding. The spherical shape and size of the glass particulate is set such that the glass passes through any of the molding equipment without causing an increase in pressure or reduction in flow rates. In fact, the circular nature of the glass material can in fact increase the moldability of the thermoplastic.

A substantial need exists in improving the ability of the spherical glass material in enabling the thermoplastic molding processes, but at the same time improving the rheology, tensile or modulus properties of the thermoplastic molded product. We have surprisingly found that a garnet and glass composite particulate can be manufactured by distributing a smaller garnet particulate onto the surface of a larger glass sphere using interfacial modifier/sintering technology to produce a garnet-coated glass sphere.

### BRIEF DESCRIPTION

We have found a composite that is useful in a thermoplastic molded part. In the claimed composite, a layer of smaller garnet particulate is adhered to larger glass spheres using an interfacial modifier (IM). The interfacial modification techniques are effective at bonding or fusion of a peripheral layer of garnet to glass. A garnet particulate is selected such that the smaller garnet particles can be formed into a layer covering the larger glass. After this structure is formed the resulting garnet/glass composite combined with a second interfacial modifier (IM). The modified garnet coated glass is easily dispersed into a continuous thermoplastic polymer phase.

A broad range of glass particulate sizes can be used in these composite garnet coated glass. Typically, the glass can range from as large as 2 mm (2000 μ) to as small as 30-50 μ. Similarly, the garnet can be about 5 to 200 μ. In order, however, to obtain a layer formation on the surface of the glass the glass particle is typically 6-10 larger than the garnet particle.

An aspect is a polymer composition having a glass/garnet composite dispersed into a thermoplastic polymer at use concentrations or in increased masterbatch concentrations.

Another aspect is an abrasive comprising a backing sheet and adhesively affixed there to an array of the glass/garnet composite particles.

The initial development was to develop a spherical abrasive particulate. Garnet, having an aspherical surface, when formed with an interfacial modifier (IM), on a surface layer on a glass bed provides an abrasive character to an otherwise relatively smooth glass surface. In the absence of an IM no significant fusion of garnet peripheral particle to glass sphere core can occur. We found that the interfacial bond between the garnet and glass bead was exceptional. The strength of the interfacial bond between the glass core to garnet particle exceeded that of the garnet itself. The cohesive failure of the garnet occurred followed by glass core bead damage.

The claimed composite is a material comprising a central glass core or bead, having bonded thereto an aspherical garnet particle with a jagged morphology using an interfacial modifier (IM) in a sintering process such that the garnet is bonded to the glass with non-volatile components from the interfacial modifier (IM) after sintering. We further found that an interfacially modified composite can be used as a thermoplastic additive in molding thermoplastic materials.

The surface bonded and peripheral garnet retained the innate aggressive angular shape after fusion to the glass core bead. The fusion of glass core sphere to garnet required sinter heating of the mixed components. This initial development work was completed using a laboratory static/batch sintering oven and ceramic crucibles. We noted that the post-sintered structure remained spherical as there was no distortion of the glass core during softening nor multiple layer deposition of the garnet upon the glass bead core. This single layer deposition was anticipated since the garnet is refractory at the temperatures needed to fuse the structure. This monolayer deposition of the garnet and retention of the spherical core shape created end articles that still had a strong tendency to roll and in thermoplastic processing remain rheologically favorable. The beaded garnet spheres easily rolled underneath the fingertips when pressed on a hard surface. This initial development work was done with garnet at about 50 to 150 microns and glass cores at about the 1000 to 1500 micron diameter range. See FIG. 1. These composites would be suitable as abrasive particles in aggressive products such as 40 to 100 grit sandpaper and other like products. One thousand micron and smaller would be applicable in greater than 100 grit abrasive products.

We then extended the development to composites with smaller dimensions. Smaller glass core spheres as small as 15 microns and garnet particles as small as 3 microns was seen to work in improving the thermoplastic processes. In this application the interfacial modifier coats the garnet/glass composite and acts to improve the dispersion of the composite into the polymer. The resulting polymer blend obtains improved rheology, tensile and modulus properties. In this way the IM acts both to bond garnet to glass but also acts to improve the properties of any resulting polymer composite.

The value of the garnet/glass composite is that the spherical nature of the composite mimics the rheological properties of the glass in a thermoplastic molding process, while at the same time the non-spherical and, in fact, jagged and irregular morphology of the garnet material distributed across the glass surface improves the rheology, tensile and modulus properties of the glass sphere. The glass garnet composite material is useful in any thermoplastic molding processing technology.

The term “composite” refers to a combination of core glass bead, a peripheral garnet particulate and an atom distribution derived from an IM in a fused layer surrounding each core.

The term “particulate” refers to a collection of finely divided particles. The particulate has a range of sizes and morphologies. The maximum glass particle size is less than 2 mm. The maximum garnet particle size is less than 350 microns. The particulate comprises a glass core coated with peripheral garnet and nonvolatile components of an IM. The composite can be dispersed into a thermoplastic polymer.

The term “interfacial modifier” (IM) means a compound with an inorganic central atom and two or more organic substituents. Such a metal organo compound can coat the surface of any part of the core, or glass particulate and does not react with the other components of the solid particles or with itself during thermoplastic processing. An IM coated substrate is non-reactive with itself and/or other uncoated substrates. In one embodiment, the IM is an organo-metallic compound. In one embodiment, an organo-metallic IM comprises a group 13/IIIA or 4/IVB metal or metalloid central atom having organic substituents.

The term “sinter” refers to a process in which sufficient heating causes fusion or bonding to form a solid. In a sinter process the glass does not melt but may soften and the energy of surface atoms on the core and particulate causes garnet/glass atomic migration or to form bonds that cause a fusion, bonding, or solidification. In the claimed sintering, the temperature is sufficient to fuse the coating, volatilize organic components of the IM, but not so high as to liquify or melt the glass. In the claimed sintering, the central atom or metal component of the IM remains in a surface distribution, component or coating derived from the IM. After sintering the metal participates in the bonding or fusion.

The term(s) “fusion,” “fused,” “bond” or “bonded” means that the glass, garnet, and the interphase layer form a robust mechanically stable structure. The structure can be assembled and sintered with substantial yield and can be combined into an end use with minimal structural damage to itself and substantial yield of useful end products. The bond is formed by sintering wherein atoms from both the peripheral garnet and glass particulate and non-volatile components of the IM combine in a fused layer. The bond is formed at a temperature below the melting point in the glass. The core may soften without loss of shape but not melt. The core can retain its initial nature except for the bond at the interface. The bond can comprise an alloy structure or a structure formed as atoms from the coating and core diffuses on and into the other into the bond structure therebetween. The final structure has a distribution of smaller garnet particles on the glass surface.

The term “extrudate” typically refers to a product of an extrusion process. In an extrusion process, a composite is typically heated to an appropriate temperature and passed through an extruder using the force applied from a rotating (blank). The warmed extrudate is then passed through a die that imparts a specific shape to the extrudate.

The term “master batch” refers to a thermoplastic composite having increased amounts of particulate (often greater than 30 wt. %, typically about 50-70 wt. %) components in a polymer phase that can be combined and diluted with additional neat polymer to the final use concentrations of the composite components. Polymer as used in a product is often less than 50 wt. % or less than 30 wt. %. In use, a masterbatch can be used by combining a polymer, often as a pellet of neat polymer, and a masterbatch, often in the form of a pellet, into heated forming equipment, such an extruder or molder, to make a product at a designed use concentration of particulate.

The terms “thermoplastic rheology and modulus and tensile properties” are used in their common and accepted meaning. Thermoplastic rheology broadly refers to the improved melt flow of a thermoplastic composite through an extruder, molder, or other heated molding equipment. The terms “modulus and tensile properties” refer to the nature of the stress/strain as the composite is exposed to an outside extending, twisting or compression force.

### BRIEF DESCRIPTION OF THE FIGURES

FIG. 1 is a photo micrograph of a composite garnet/glass composite in cross section that is imbedded into a curable acrylic.

FIG. 2 is a bar graph showing the melt temperature vs. torque behavior of a composite of a thermoplastic (TPO) polyolefin and various combinations of the disclosed components.

FIG. 3 is a graph of the improved flexural modulus of a claimed polymer and composite.

### DETAILED DISCUSSION

Novel composites are made by coating a core glass bead with an IM followed by distributing a smaller peripheral garnet particulate onto the coated surface of the glass bead. The resulting structure is sintered, forming a glass bead with a garnet particulate bonded to the surface of the glass bead through the non-volatile residue of the IM coating. Once formed the composite can then be dispersed into a thermoplastic polymer phase to improve rheology of thermoplastic processing and tensile and modulus properties.

### Garnet

Garnets can be natural or synthetic. Garnets can have the general formula:

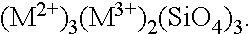

The M²⁺ can be divalent metal cations (Ca²⁺, Mg²⁺, Fe²⁺, Mn²⁺) and the M³⁺ site by trivalent metal cations (Al³⁺, Fe³⁺, Cr³⁺) or mixtures of any of them in a crystalline form. Garnets are most often found as a dodecahedral crystal, in the trapezohedron or hexoctahedral form. They crystallize in the cubic system, having three axes that are all of equal length and perpendicular to each other, but are never actually cubic because, despite being isometric, the {100} and {111} families of planes are depleted. Garnets do not have any cleavage planes, so when they fracture under stress, sharp, irregular (conchoidal) pieces are formed. Major types are: Pyrope (Mg₃Al₂Si₃O₁₂) Almandine (Fe₃Al₂Si₃O₁₂) Spessartine (Mn₃Al₂Si₃O₁₂) Andradite (Ca₃Fe₂Si₃O₁₂) Grossular (Ca₃Al₂Si₃O₁₂) and Uvarovite (Ca₃Cr₂Si₃O₁₂). Minor amounts of impurities can be seen.

Garnet particles generally useful in the claimed materials are smaller than the glass core. These sizes obtain a coating of garnet that is mainly a single layer distribution of garnet on the glass core the exposes the garnet effectively throughout the surface in a random or uniform distribution. A particle size is selected such that a distribution of garnet can be formed on the larger glass core surface.

### Glass

The glass core particulate can be any substantially spherical or aspherical glass core.

The surface area of the central glass sinter component is covered by the IM layer in 50 to 100% or 80 to 99% coverage in a fused layer of the coating. While the surface does not need to be completely covered by garnet, the surface typically has nearly a fully formed IM surface layer. These glass cores are solid and preferably not hollow and can be strong enough to avoid being crushed or broken during further processing, such as by high pressure spraying, kneading, extrusion, or injection molding. In some embodiments these spheres have particle sizes close to the sizes of other particulate if mixed as one material.

In some embodiments, the large central component or the glass core component, can include at least silica or alumina. In some embodiments that include silica, the silica can be, for example, fumed silica, precipitated silica, surface modified silica, or nano-silica. In some embodiments the composite can comprise glass sinters comprising aluminosilicate, boron trioxide, borophophosilicate, borosilicate, barium titanate, cobalt, fluorophosphate, fluorosilicate, germanium dioxide, lead glass, opaline glass, soda lime, sodium hexametaphosphate, sodium silicate, tellurite, thoriated glass, uranium glass, or vitrite.

### Interfacial Modifier

Interfacial modifiers used in the application fall into broad categories including Group IIIA, or Group VIB element compounds, for example, titanate compounds, zirconate compounds, hafnium compounds, samarium compounds, strontium compounds, neodymium compounds, yttrium compounds, phosphonate compounds, aluminate compounds and zinc compounds. Aluminates, boronates, phosphonates, titanates and zirconates that are useful contain from about 1 to about 3 ligands comprising hydrocarbyl phosphate esters and/or hydrocarbyl sulfonate esters and about 1 to 3 hydrocarbyl ligands which may further contain unsaturation and heteroatoms such as oxygen, nitrogen, and sulfur.

In one embodiment, the IM that can be used is a type of organo-metallic material such as organo-cobalt, organo-iron, organo-boron, organo-nickel, organo-titanate, organo-aluminate organo-strontium, organo-neodymium, organo-yttrium, organo-zinc, or organo-zirconate. The specific type of organo-titanate, organo-aluminates, organo-boronate, organo-strontium, organo-neodymium, organo-yttrium, organo-zirconates which can be used, and which can be referred to as organo-metallic compounds are distinguished by the presence of at least one hydrolysable group and at least one organic moiety. Mixtures of organo-metallic materials may be used.

Certain of these types of compounds may be defined by the following general formula: M (R₁)ₙ(R₂)ₘ wherein M is a central atom selected from such metals as, for example, Ti, Al, and Zr and other metal centers; R₁ is a hydrolysable group; R₂ is a group consisting of an organic moiety, preferably an organic group that is non-reactive with polymer or other film former; wherein the sum of m+n must equal the coordination number of the central atom and where n is an integer ≥1 and m is an integer ≥1. Particularly R₁ is an alkoxy group having less than 12 carbon atoms. Other useful groups are those alkoxy groups, which have less than 6 carbons, and alkoxy groups having 1-3 C atoms. R₂ is an organic group including between 6-30, preferably 10-24 carbon atoms optionally including one or more hetero atoms selected from the group consisting of N, O, S and P. R₂ is a group consisting of an organic moiety, which is not easily hydrolyzed and is often lipophilic and can be a chain of an alkyl, ether, ester, phospho-alkyl, phospho-alkyl, phospho-lipid, or phospho-amine. The phosphorus may be present as phosphate, pyrophosphato, or phosphito groups. Furthermore, R₂ may be linear, branched, cyclic, or aromatic. R₂ is substantially unreactive, i.e., not providing attachment or bonding, to other particles. Titanates provide antioxidant properties and can modify or control cure chemistry. A titanate material can be 2-propanolato, tris iso-octa-decanato-O-titanium IV, an isopropyl tri-isostearoyl titanate. Zirconate provides excellent coating and reduces formation of off color in formulated thermoplastic materials. A useful zirconate material is neopentyl (diallyl) oxy-tri (dioctyl) phosphato-zirconate.

The use of an IM results in workable viscosity and improved structural properties in a final use such as a structural member or shaped article. Minimal amounts of the modifier can be used including about 0.005 to 10 wt.-%, about 0.01 to 8 wt.-%, about 0.05 to 6 wt.-%, or about 0.04 to 2 wt. % based on the weight final composite.

The IM coating, with no other components, can be formed as a coating of a dimension equal to at least 3 molecular layers of IM. A substantially complete IM coating has a thickness of less than 1500 Angstroms often less than 200 Angstroms, and commonly 100 to 5000 Angstroms (Å) 50 to 1000 Angstroms (Å) or 10 to 500 Angstroms (Å).

A composite is more than a simple admixture with properties that can be predicted by the rule of mixtures. A composite is defined as a combination of two or more substances at various percentages, in which each component results in properties of the composite material that are in addition to or superior to those of its constituents. In a simple admixture, the mixed material has little interaction and little property enhancement. In a composite material, at least one of the materials can be chosen to increase stiffness, strength, or density.

The atoms and molecules in the components of the composite can form bonds with other atoms or molecules using several mechanisms. Such bonding can occur between the electron cloud of an atom or molecular surfaces including molecular-molecular interactions, atom-molecular interactions, and atom-atom interactions. Each bonding mechanism involves characteristic forces and dimensions between the atomic centers even in molecular interactions. The important aspect of such bonding force is strength and the variation of bonding strength over distance and directionality. The major forces in such bonding include ionic bonding, covalent bonding, and the van der Waals' (VDW) types of bonding.

Ionic radii and bonding occur in ionic species such as Na⁺Cl⁻, Li⁺F⁻. Such bonding is substantial, often substantially greater than 100 kJ-mol⁻¹ often greater than 250 kJ-mol⁻¹. Further, the interatomic distance for ionic radii tend to be small and can be 1-3 Å. Covalent bonding results from the overlap of electron clouds surrounding atoms forming a direct covalent bond between atomic centers. The covalent bond strengths are substantial, are roughly equivalent to ionic bonding and tend to have somewhat smaller interatomic distances.

The varied types of van der Waals' forces are different than covalent and ionic bonding. These van der Waals' forces tend to be forces between molecules, not between atomic centers. In the composites of the claimed materials strong covalent or ionic bonding is avoided. Reactive coupling agents that bond polymer to particle are not used. The blended particle polymer composite as shown in the embodiments is formed with van der Waals bonding as modified and reduced by the IM coating.

Such VDW forces, because of the nature of the fluctuating polarization of the molecule, tend to be low in bond strength, typically 50 kJ mol⁻¹ or less. Further, the range at which the force becomes attractive is also substantially greater than ionic or covalent bonding and tends to be about 3-10 Å.

In the interfacial modifier (IM) modified van der Waals composite materials, we have found that the unique combination materials result in the creation of a unique minimal van der Waals' bonding. The van der Waals' forces arise between molecules/aggregates/crystals and are created by the combination of particle size, polymer, and IMs in the composite.

The claimed materials are characterized by a composite having intermolecular forces between particles less than about 30 kJ-mol⁻¹ and a bond dimension of 3-10 Å.

The modified particle surface has a substantially complete coating of an interfacial modifier (IM) with a thickness of less than 1500 Angstroms often less than 200 Angstroms, and commonly 10 to 500 Angstroms (Å) or 100 to 1500 Angstroms (Å).

In this application the IM coats the garnet/glass composite and acts to improve the rheology of the processing and the tensile and modulus properties of the combination of a thermoplastic and the garnet/glass composite. In this way the IM acts both to bond garnet to glass but also acts to improve the properties of any resulting polymer composite. The process and physical property benefits of utilizing the coating becomes evident when packing to a significant proportion of the maximum packing fraction; this value is typically greater than approximately 70, 80, 90, 92 or 95 volume or weight % of the coated particulate phase in the composite.

### Polymers

A large variety of thermoplastic polymer and copolymer materials can be used in the composite materials. We have found that polymer materials useful in the composite include both vinyl or condensation polymeric materials and blended materials.

Vinyl polymers are typically manufactured by the polymerization of monomers having an ethylenically unsaturated olefinic group. Condensation polymers are typically prepared by a condensation polymerization reaction which is typically considered to be a stepwise chemical reaction in which two or more molecules combined, often but not necessarily accompanied by the separation of water, methanol, or some other simple, typically volatile substance. Such polymers can be formed in a process called polycondensation. The typical polymer has a melt index of about 0.5 to 50 g-10 min⁻¹, a density of at least 0.85 gm-cm⁻³, however, polymers having a density of greater than 0.96 are useful to enhance overall product density. A density is often 0.94 to 1.7 or up to 2 gm-cm⁻³ or can be about 0.96 to 1.95 gm-cm⁻³.

Vinyl polymers include polymer of alpha-olefins such as ethylene, propylene, etc.; polymers of chlorinated monomers such as vinyl chloride, vinylidene chloride, acrylate monomers such as acrylic acid, methyl acrylate, methyl methacrylate, acrylamide, hydroxyethyl acrylate, and others; styrenic monomers such as styrene, alpha-methyl styrene, vinyl toluene, etc.; vinyl acetate; polyacrylonitrile; and other commonly available ethylenically unsaturated monomer compositions. Examples include polyethylene, polypropylene, polybutylene, acrylonitrile-butadiene-styrene (ABS), polybutylene copolymers, polyacetal resins, polyacrylic resins, homopolymers, etc. Useful polymers are halogen polymers such as homopolymers, copolymers, and blends comprising vinyl chloride, vinylidene chloride, fluorocarbon monomers, etc. Polyvinyl chloride polymers with a K value of 50-75 can be used. A characteristic of PVC resin is the length or size of the polymer molecules. A measure of the length or size is molecular weight of PVC. A useful molecular weight can be based on measurements of viscosity of a PVC solution. Such a K value usually ranges between 35 and 80. Low K-values imply low molecular weight (which is easy to process but has properties consistent with lower polymer size) and high K-values imply high molecular weight, (which is difficult to process, but has properties consistent with polymer size). The most commonly employed molecular characterization of PVC is to measure the one-point-solution viscosity. Expressed either as inherent viscosity (IV) or K-value, this measurement is used to select resins for the use in extrusion, molding, as well as for sheets, films, or other applications. The inherent viscosity (IV) or K-value is the industry standard (ISO 1628-2) starting point for designing compounds for end use. Polymer solution viscosity is the most common measurement for further calculation of inherent viscosity or the K-value because it is an inexpensive and routine procedure that can be used in manufacturing as well as in R&D labs.

Condensation polymers include nylon, phenoxy resins, polyarylether such as polyphenylether, polyphenylsulfide materials; polycarbonate materials, chlorinated polyether resins, polyethersulfone resins, polyphenylene oxide resins, polysulfone resins, polyimide resins, thermoplastic urethane elastomers and many other resin materials. Condensation polymers that can be used in the composite materials include polyamides, polyamide-imide polymers, polyarylsulfones, polycarbonate, polybutylene terephthalate, polybutylene naphthalate, polyetherimides, polyether sulfones, polyethylene terephthalate, thermoplastic polyamides, polyphenylene ether blends, polyphenylene sulfide, polysulfones, thermoplastic polyurethanes and others. Preferred condensation engineering polymers include polycarbonate materials, polyphenyleneoxide materials, and polyester materials including polyethylene terephthalate, polybutylene terephthalate, polyethylene naphthalate and polybutylene naphthalate materials.

A variety of polyester condensation polymer materials including polyethylene terephthalate, polybutylene terephthalate, polyethylene naphthalate, polybutylene naphthalate, etc. can be useful in composites. Polyethylene terephthalate and polybutylene terephthalate are high performance condensation polymer materials. Such polymers are often made by a copolymerization between a diol (ethylene glycol, 1,4-butane diol) with dimethyl terephthalate. In the polymerization of the material, the polymerization mixture is heated to a high temperature resulting in the transesterification reaction releasing methanol and resulting in the formation of the engineering plastic. Similarly, polyethylene naphthalate and polybutylene naphthalate materials can be made by copolymerizing as above using as an acid source, a naphthalene dicarboxylic acid. The naphthalate thermoplastics have a higher T_{g} and higher stability at high temperature compared to the terephthalate materials. However, all these polyester materials are useful in composite materials. Such materials have a preferred molecular weight characterized by melt flow properties. Useful polyester materials have a viscosity at 265° C. of about 500-2000 cP, preferably about 800-1300 cP

Another class of thermoplastics includes styrenic copolymers. The term styrenic copolymer indicates that styrene is copolymerized with a second vinyl monomer resulting in a vinyl polymer. Such materials contain at least a 5 mol.-% styrene and the balance being 1 or more other vinyl monomers. An important class of these materials is styrene acrylonitrile (SAN) polymers. SAN polymers are random amorphous linear copolymers produced by copolymerizing styrene acrylonitrile and optionally other monomers. Emulsion, suspension, and continuous mass polymerization techniques have been used. SAN copolymers possess transparency, excellent thermal properties, good chemical resistance, and hardness. These polymers are also characterized by their rigidity, dimensional stability, and load bearing capability. Olefin modified SAN's (OSA polymer materials) and acrylic styrene acrylonitrile (ASA polymer materials) are known. These materials are somewhat softer than unmodified SAN's and are ductile, opaque, two phased terpolymers that have surprisingly improved weatherability.

Important classes of engineering polymers that can be used include acrylic polymers. Acrylics comprise a broad array of polymers and copolymers in which the major monomeric constituents are an ester acrylate or methacrylate. These polymers are often provided in the form of hard, clear sheets or pellets. Acrylic monomers polymerized by free radical processes initiated by typically peroxides, azo compounds or radiant energy. Commercial polymer formulations are often provided in which a variety of additives are modifiers used during the polymerization provide a specific set of properties for certain applications. Pellets made for polymer grade applications are typically made either in bulk (continuous solution polymerization), followed by extrusion and pelleting or continuously by polymerization in an extruder in which unconverted monomer is removed under reduced pressure and recovered for recycling. Using methyl acrylate, methyl methacrylate, higher alkyl acrylates and other polymerizable vinyl monomers commonly makes acrylic plastics. Preferred acrylic polymer materials useful in composites have a melt index of about 0.5 to 50, preferably about 1 to 30 gm./10 min.

Polymer blends or polymer alloys can be useful in manufacturing the claimed pellet or linear extrudate. Such alloys typically comprise two miscible polymers blended to form a uniform composition. Scientific and commercial progress in the area of polymer blends has led to the realization that important physical property improvements can be made not by developing new polymer material but by forming miscible polymer blends or alloys. A polymer alloy at equilibrium comprises a mixture of two amorphous polymers existing as a single phase of intimately mixed segments of the two macro molecular components. Miscible amorphous polymers form glasses upon sufficient cooling and a homogeneous or miscible polymer blend exhibits a single, composition dependent glass transition temperature (T_{g}). Immiscible or non-alloyed blend of polymers typically displays two or more glass transition temperatures associated with immiscible polymer phases. In the simplest cases, the properties of polymer alloys reflect a composition-weighted average of properties possessed by the components. In general, however, the property dependence on composition varies in a complex way with a property, the nature of the components (glassy, rubbery, or semi-crystalline), the thermodynamic state of the blend, and its mechanical state whether molecules and phases are oriented.

### Example 1

### Procedure/Methodology:

TABLE 1
Raw Material List:

| Ingredient | Function |
|---|---|
| 1.8-2.1 mm diameter Glass Bead | Core Glass |
| Media | |
| About 210 micron (80-grit) | Peripheral garnet |
| Garnet Abrasive | |
| Interfacial modifier | Promotes glass to garnet |
| | fusion |

TABLE 2
Equipment List:

| Item | |
|---|---|
| Sinter oven | Garnet/glass fusion |
| US Mesh 45 um sieve | Separate unfused excess garnet |
| | powder from the |
| | desired composite |
| Heat Gun | Distribute/Promote coating IM |
| | on garnet covered spheres |
| Coors Crucible | |

The 1.8-2.1 mm glass beads were sifted with a 2.00 mm sieve size. The smaller diameter (<2000 micron) of the spheres were collected and used. Seven grams of glass beads were placed into the Coors crucible. Sixteen drops of interfacial modifier (approximately 0.4 grams) were added to the glass beads. The crucible contents were stirred, and the glass was coated (30-40 seconds). Added approximately 21 grams of 210 micron (80-grit) garnet to the crucible. Carefully mixed the contents of the crucible. Careful stirring enhanced coverage of garnet onto the beads. The garnet began to adhere to the glass beads as the contents were stirred.

Preheated the sintering oven to 850° C. Added the coated material into a crucible. Placed the crucible directly into the middle of the furnace chamber. Heated at temperature for 35 minutes. Then removed the crucible from the oven and cooled naturally for 20 minutes. Carefully sieved the product to remove particles larger than 2.8 mm and smaller than 1 mm, keeping a size selection containing the majority of the garnet coated glass. This removes larger material made up of fused glass without garnet and the smaller garnet not fused to the glass.

### Example 2

### Procedure/Methodology:

TABLE 3
Raw Material List:

| Ingredient | Function |
|---|---|
| Glass bead 45-90 micron | Core Glass |
| garnet powder 13-16 micron; | Peripheral garnet |
| 600 mesh | |
| Interfacial modifier | Promotes glass to garnet |
| | fusion |
| Ethylene octene polymer | Polymer phase |

TABLE 4
Equipment List:

| Item | |
|---|---|
| Lab Calciner | Garnet/glass fusion |
| US Mesh 45 um sieve | Separate unfused excess garnet |
| | powder from the |
| | desired composite |
| Heat Gun | Distribute/Promote coating IM |
| | on garnet covered spheres |
| Rotating coater | Rotate garnet covered spheres |
| | while applying IM to obtain |
| | uniform coating. |
| Metallurgical press, 1.25 | Compression mold post-fused |
| inch dia. die set, jacketed | polymer and modified garnet |
| heater, and loadcell | covered spheres |
| Instron Universal testing | Modulus measurements |
| machine | |
| Helium pycnometer | Determine true density of key |
| | Components - QC |
| | components and blends for |
| | validation of target to actuals. |

Two parts IM were added to 75 parts glass core beads. IM coated onto glass bead surface with stirring of a stainless steel spatula. Twenty five parts of garnet powder were placed in a beaker and stirred to form uniform coverage of garnet over the modified bead surface. The blend was placed into the 2 in diameter lab calciner held at a 5° angle at 875° C. and rotated at 4 RPM. As the calciner rotated, the sintered contents were collected in a metal pan. Upon cooling, the material were classified by size in a 53 micron 8″ diameter Ro-Tap sifting screen. Excess garnet (size <16 micron) is sieved out leaving the desired size >53 micron diameter product that appeared to comprise a coated 90 micron sphere.

An IM was added to the fused glass/garnet beads. The material was blended with a stainless steel spatula causing the IM to coat the fused glass/garnet beads by heating materials to a maximum temperature of about 135 to 140° C.

We blended composite and a polymer phase via Brabender Fusion Bowl as follows. Formulations targeted a volume fraction of 0.30 of the composite within the polymer phase. Formulations were adjusted to maintain that precise raw particulate level to compensate for varying amounts of IM (0 pph minimum to 3.00 pph maximum).

The garnet/glass technology concept is viable. It is easily produced via rotary calcination with an IM. The garnet coated glass spheres disperse into a polymer phase, interlock into the surrounding polymer, impart higher flexural modulus, yield strength, and maintain at least some ability to improve tensile and modulus. However, use of IM that improves compatibility of the composite obtains reinforcement without substantially negatively affecting rheology.

TABLE 5
Exemplary embodiments of Garnet/Glass Composites

| Component | Useful size | Useful size | Useful size | Useful size |
|---|---|---|---|---|
| Glass | 2000-1000μ | 1000-500μ | 500-100μ | 100μ-50μ |
| Garnet | <300μ | <200μ | <100μ | <10μ |

TABLE 6
Exemplary embodiments of Garnet/Glass Composites

| Component | Useful size | Useful size | Useful size |
|---|---|---|---|
| Glass | 100μ-2 mm | 150μ-1 mm | 200μ-500μ |
| Garnet | 10-350μ | 20-300μ | 30-250μ |

TABLE 7
Exemplary embodiments of Garnet/Glass Composites

| Component | Useful size | Useful size | Useful size |
|---|---|---|---|
| Glass | 30μ-500μ | 40μ-400μ | 50μ-300μ |
| Garnet | 5μ-100μ | 5μ-60μ | 5μ-80μ |

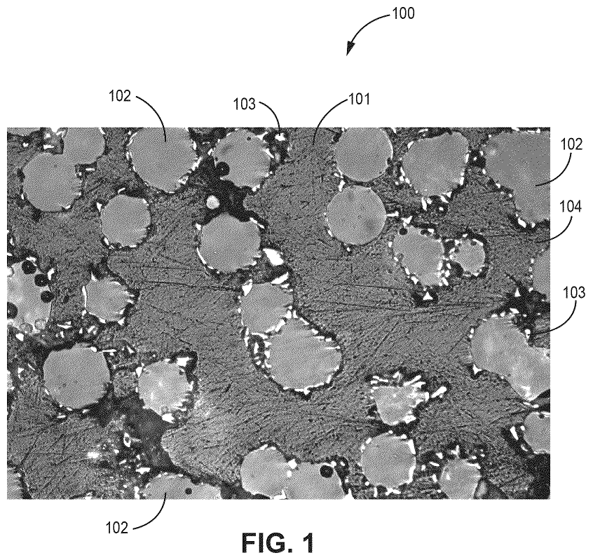

FIG. 1 is a photo micrograph of a composite garnet/glass composite in cross section that is embedded into a curable acrylic. The rigid composite is formed by mixing a glass/garnet particle similar to that in Example 1 in a liquid but curable acrylic resin, curing to a solid and then abrading it to show the composite in cross section imbedded in the solid matrix. In FIG. 1 is seen a solid matrix 100, solid acrylic resin 101, 104, glass spheres 102, and the garnet particulate 103 shown is an array of particulate on the glass surface.

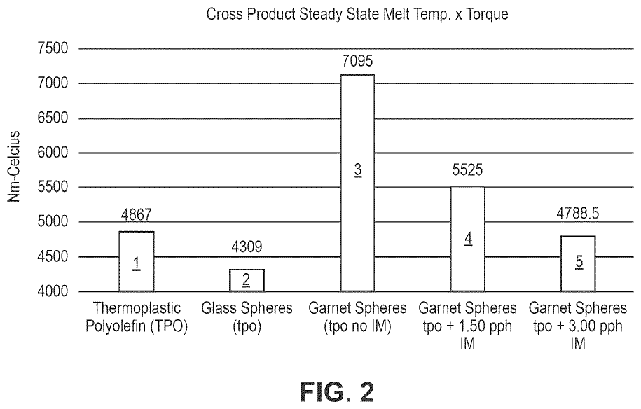

FIG. 2 is a series of bar graphs showing the melt temperature vs. torque behavior of a composite of a thermoplastic polymer (TPO) and various combinations of the disclosed components. In FIG. 2 bar graph 1 is the measurement for the neat thermoplastic polymer (TPO) with no additions. Bar graph 2 is the measurement of the TPO plus glass. Bar graph 3 is the measurement of a garnet TPO composite. Bar graph 4 is the measurement of the garnet/glass TPO composite at a specific concentration of IM. Bar graph 5 is the measurement of the garnet/glass TPO composite at a specific but higher concentration of IM. The use of an IM to enhance the formation of the garnet/glass and TPO composite shows little functionality if any is lost in using the IM containing composite.

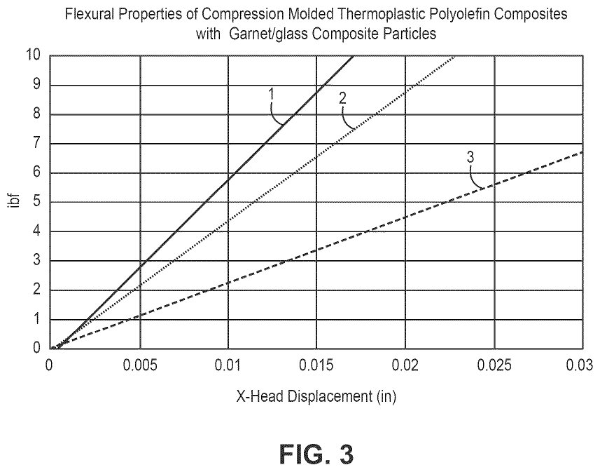

FIG. 3 is a graph of the improved flexural modulus of a claimed polymer and composite. In FIG. 3, the dashed line 3 is the neat thermoplastic polyolefin with neither glass nor garnet. Dotted line 2 is the glass polymer blend with no garnet. Solid line 1 is the composite of the thermoplastic polyolefin and the glass/garnet particulate. Each line represents the initial slope of the displacement curve (not shown) of each test machine tracing and is accepted as strong evidence of improvement in flex modulus.

### Pellet

The composite at use concentration and the master batch composite can be made from a pellet through extrusion through a shaping die. Pellets are commonly made by extruding the compounded material through a pelleting die and cutting the pellets to size as they emerge from the die. Such a pellet made of the composite can be used as an intermediate between the compounding of the composite and the manufacturing of the final thermoplastic product. A pellet can comprise the composite comprising the components in use concentration of components designed to be directly converted or used in making a useful article. Alternatively, the pellet can comprise a master batch composition with increased amounts, e.g., about 2 to 10 times the amount of ferrous particle such that the pellet can be combined with polymer in proportions that result in producing use concentrations. The pellet is a roughly cylindrical object that can be fed into an extruder input. The pellet is typically 1 to 50, 1 to 60, 1 to 70, 1 to 80, 1 to 90, or 1 to 100 mm in length and 1 to 5, 1 to 10, 1 to 15, or 1 to 20 mm in diameter. A pellet weighs about 10 to 100 mg, 10 to 80 mg, 10 to 70 mg, 10 to 60 mg, 10 to 50 mg, 20 to 50 mg, 20 to 60 mg, 20 to 70 mg, 20 to 80 mg.

The claims may suitably comprise, consist of, or consist essentially of, or be substantially free or free of any of the disclosed or recited elements. The claimed technology is illustratively disclosed herein can also be suitably practiced in the absence of any element which is not specifically disclosed herein. The various embodiments described above are provided by way of illustration only and should not be construed to limit the claims attached hereto. Various modifications and changes may be made without following the example embodiments and applications illustrated and described herein, and without departing from the true spirit and scope of the following claims.

While the above specification shows an enabling disclosure of the composite technology, other embodiments may be made with the claimed materials. Accordingly, the disclosed fused particulate and polymer composite is embodied solely in the claims hereinafter appended.

We claim:

1. A garnet and glass composite particulate comprising a sintered particulate comprising:
a glass core having a particle size of 300 microns to 2 mm, and fused to the glass core, a plurality of peripheral garnet particles having a particle size of 50 to 300 microns; and a coating residue fusing the garnet to the glass core;
wherein the glass particle size is from 6-10 times greater than the garnet particle size, the coating is residue from a sintered interfacial modifier composition and the coating residue with the substrate and the peripheral bead form a robust mechanically stable bond between the peripheral bead and the core bead.

2. The composite of claim 1 wherein the peripheral garnet is a particulate with a jagged particle morphology.

3. The composite of claim 1 wherein the peripheral garnet does not fully occupy the entire surface of the core glass.

4. The composite of claim 1 wherein the glass has a diameter of 500-100 μ and the peripheral garnet has a diameter greater than 50μ.

5. The composite of claim 1 wherein the glass has a diameter of 50-100 μ and the peripheral garnet has a diameter greater than 10μ.

6. The composite of claim 1 wherein the glass has a diameter of 1000-500 μ and the peripheral garnet has a diameter greater than 100μ.

7. The composite of claim 1 wherein the glass has a diameter of 2000-1000 μ and the peripheral garnet has a diameter greater than 200μ.

8. The composite particulate of claim 1 wherein the glass core bead has a diameter of about 500 microns-1.6 mm.

9. The composite of claim 1 wherein the peripheral beads forms at least one layer of peripheral garnet particles on the surface of the substrate.

10. The composite of claim 9 wherein the peripheral beads form a single layer of randomly placed peripheral garnet particles on the surface of the substrate.

11. The composite of claim 1 wherein the interfacial modifier is an organo metallic.

12. The composite of claim 1 wherein the interfacial modifier is used at about 0.05 to 2 wt. % based on the weight of the glass/garnet composite.

13. A garnet and glass composite particulate comprising a sintered particulate comprising:
a glass core having a particle size of 10 microns to 300 microns, and fused to the glass core, a plurality of peripheral garnet particles having a particle size of 5 to 100 microns; and a coating residue fusing the garnet to the glass core; wherein the coating is residue from a sintered interfacial modifier composition and the coating residue with the substrate and the peripheral bead form a robust mechanically stable bond between the peripheral bead and the core bead, wherein the glass particle size is from 6-10 times greater than the garnet particle size.

14. The composite of claim 13 wherein the peripheral garnet has a diameter of about 5-80μ.

15. The composite particulate of claim 13 wherein the glass core bead has a diameter of about 20-300 mm.

16. The composite particulate of claim 13 wherein the glass core bead has a diameter of about 25-70 mm.

17. A master batch comprising a thermoplastic polyolefin and greater than 30 wt. % of the glass and garnet composite of claim 1.

18. A master batch comprising a thermoplastic polyolefin and 50 to 70 wt. % of the glass and garnet composite of claim 1.

19. A master batch comprising a thermoplastic polyolefin and greater than 30 wt. % of the glass and garnet composite of claim 13.

20. A master batch comprising a thermoplastic polyolefin and 50 to 70 wt. % of the glass and garnet composite of claim 13.
